(19) United States
(12) Patent Application Publication
(10) Pub. No.: US 2007/0110072 A1
(43) Pub. Date: May 17, 2007

(54) Digital subscriber link interconnection to a virtual private network

(76) Inventor: Mark Elias, Eastpointe, MI (US)

Correspondence Address: BRINKS HOFER GILSON & LIONE, P.O. BOX 10395, CHICAGO, IL, 60610, US

(21) Appl. No.: 11/280,122

(22) Filed: Nov. 16, 2005

(51) Int. Cl. H04L 12/28

(52) U.S. Cl. 370/395.5

(57) ABSTRACT

A digital subscriber link (DSL) network providing an interconnection to a virtual private network using multi-protocol label switching (MPLS) includes a DSL source, an L2TP access concentrator (LAC) to aggregate DSL source traffic, a broadband remote access server (B-RAS) to aggregate DSL Internet traffic as well as to function as a LAC for MPLS-destined sessions, an L2TP network server (LNS) to aggregate and authenticate Internet-bound DSL traffic and to switch sessions designated for MPLS-enabled locations, and an MPLS-enabled LNS to terminate the sessions and transmit the sessions to MPLS VPN customers.

### BACKGROUND

The invention relates to Digital Subscriber Link (DSL) connections over a network. More particularly, the invention relates to DSL connections to a Multi-Protocol Label Switching (MPLS) Virtual Private Network (VPN) using a Layer 2 Tunneling Protocol Access Concentrator.

While DSL connections use asynchronous transfer mode (ATM) as their transport, most DSL connections use a protocol called PPPoE (Point to Point Protocol over Ethernet) as the encapsulation mechanism. PPPoE is not a routable protocol like IP (Internet Protocol). In fact, in the ATM network, an IP address has not been assigned to these connections. It is the function of the remote access server, such as a broadband remote access server (B-RAS) and the network server, such as a Layer 2 Transport Protocol network server (LNS) to both authenticate the subscribers (to make sure that they have authorization to be on the network) and provide an IP address for the subscriber connection that will be used for subsequent packet transmissions.

Customers may require the use of DSL as an access into Multi-Protocol Label Switching (MPLS) Layer 3 VPN's (Virtual Private Networks computer networking and telecommunications, Multi-protocol Label Switching is a data-carrying mechanism, operating at a layer below protocols such as Internet Protocol (IP) which uses an assigned IP address to control communication of data packets to a destination. It is designed to provide a unified data-carrying service for both circuit-based clients and packet-switching clients which provide a datagram service model. It can be used to carry many different kinds of traffic, including both voice telephone traffic and IP packets. MPLS may dispense with the cell-switching and signaling-protocol baggage of ATM. MPLS may provide that small ATM cells may not be needed in the core of modern networks, since modern optical networks are so fast (at 10 Gbit/s and well beyond) that even full-length 1500 byte packets may not incur significant real-time queuing delays. The need to reduce such delays, to support voice traffic, has been the motivation for the cell nature of ATM.

However, DSL traffic must first be sent to a device that can provide an IP address to the PPPoE connections. Furthermore, since a MPLS Provider Edge (PE) router may not be in the same geographical location as the B-RAS or LNS, it becomes necessary to forward and aggregate DSL traffic to these MPLS enabled locations. Aside from its ability to aggregate multiple PPPoE sessions, L2TP is a routable protocol. This may permit an L2TP tunnel and its contents to be routed over an IP network.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of a DSL network.

FIG. 2 is an example process for connecting a DSL source to a network.

FIG. 3 is a second example process for connecting a DSL source to a network.

### DETAILED DESCRIPTION

A DSL network providing an interconnection to a virtual private network using MPLS includes a DSL source, an L2TP access concentrator (LAC) to aggregate DSL source traffic, a B-RAS to aggregate DSL Internet traffic as well as to function as a LAC for MPLS destined PPPoE sessions, an L2TP network server (LNS) to aggregate and authenticate Internet-bound DSL traffic and to switch PPPoE sessions destined to MPLS-enabled locations, and an MPLS-enabled LNS to terminate the PPPoE sessions and transmit the sessions to an MPLS network.

A process for connecting a DSL source to a virtual private network includes aggregating a source of DSL data at a LAC or B-RAS; processing the DSL data including authenticating the data and assigning IP addresses to the data; switching the DSL data to be routed to MPLS-enabled locations through a second network using routable tunnels; receiving and processing the routable tunnels at an MPLS-enabled network server; and transmitting data associated with the routable tunnels to MPLS VPN customers.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

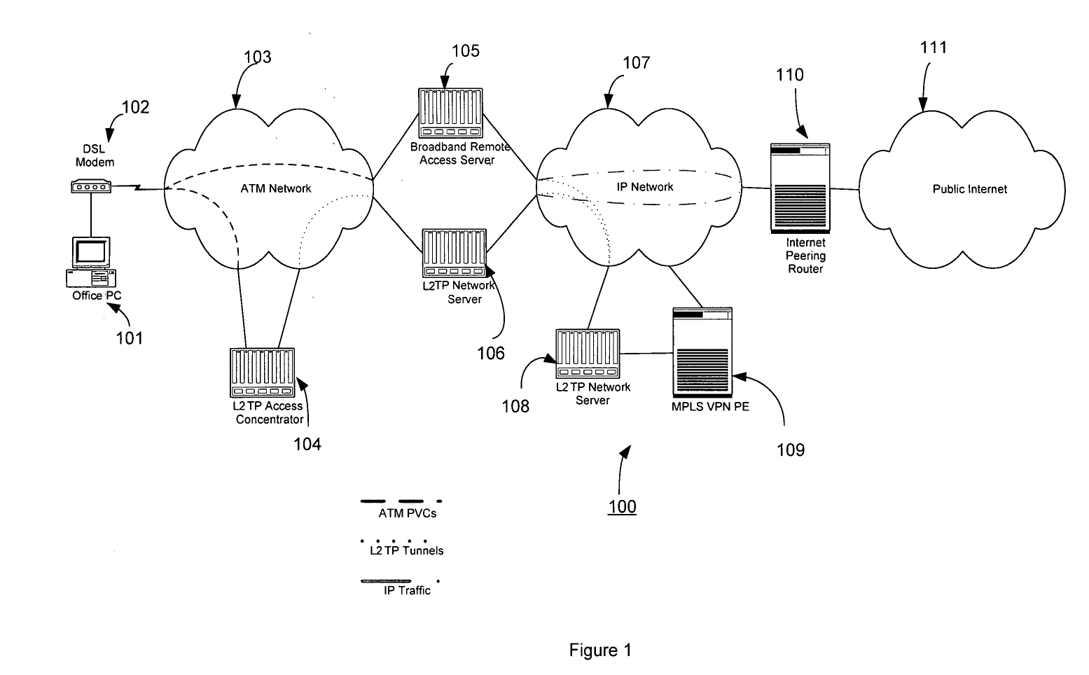

FIG. 1 illustrates a DSL connection to the Internet over a network 100. The network 100 may include a computer such as an office personal computer (PC) 101; a communications device that converts between digital DSL data from a computer or terminal and analog audio signals that can pass through a standard telephone line, such as a DSL modem 102; a network configured to route ATM data 103; a communications device that combines signals from multiple sources, such as terminals on a network, into one or more signals before sending them to their destination, or an L2TP access concentrator (LAC) 104; a server to route traffic to and from the digital subscriber line access multiplexers on an Internet service providers (ISP) network, or a broadband remote access server (B-RAS) 105; a network server configured for Layer 2 Tunneling Protocol (L2TP) operation (LNS) 106; an internet protocol (IP) network 107; a second L2TP network server (LNS) that may be configured as an MPLS LNS 108; a router between one network service provider's area and areas administered by other network providers (such as an Internet Service Provider (ISP)), or an MPLS VPN Provider Edge (PE) router 109; an Internet peering router 110, and a public Internet network 111, to which the Internet peering router 110 is in communication.

The DSL modem 102 is in communication with the office PC 101 and with the ATM network 103. The LAC 104, the B-RAS 105, and the L2TP network server 106 are in communication with the ATM network 103. The B-RAS 105, the L2TP network server 106 also are in communication with the IP network 107, as are the second L2TP network server 108, the MPLS VPN PE router 109 and the Internet peering router 110. The Internet peering router 110 is in communication with the public Internet network 111 and may serve as a bridge between the IP network 107 and the public Internet network 111. The illustrated embodiment is exemplary only. Other connections and arrangements are possible.

The B-RAS 105 may reside at the core of an ISP network, and may aggregate user sessions from the access network. An ISP may inject policy management and IP Quality of Service (QoS) at the B-RAS 105. L2TP may act as a data link layer (layer 2 of the OSI model) protocol for tunneling network traffic between two peers over an existing network, usually the Internet. L2TP is an extension of the Point-to-Point Protocol (PPP). L2TP may not provide confidentiality or strong authentication. IPSec is often used to tunnel L2TP packets and provide confidentiality and authentication. The combination of these two protocols is generally known as L2TP/IPSec, and is standardized in RFC3 193.

Asynchronous Transfer Mode Permanent Virtual Circuits (PVCs) may be passed to either the B-RAS 105 (e..g., between the ATM network 103 and the IP network 107 or to the LAC 104). A permanent virtual circuit is a virtual circuit established for repeated use between the same data terminal equipments (DTE). In a PVC, the long-term association is identical to the data transfer phase of a virtual call. Permanent virtual circuits eliminate the need for repeated call set-up and clearing.

Since the DSL traffic at the LAC 104 has not yet been broken out to IP packets, it may be forwarded over an L2TP tunnel to the LNS 106. The B-RAS 105 and LNS 106 both may handle DSL subscriber authentication and IP address assignment. Normally, DSL traffic may be destined for the Internet 111. The B-RAS 105 and LNS 106 may authenticate the subscribers (to make sure that they have authorization to be on the network) and provide an IP address for the subscriber connection that will be used for subsequent packet transmissions.

Customers may require the use of DSL as an access into MPLS Layer 3 VPN's. DSL traffic must first be sent to a device that may provide an IP address to the PPPoE connections in order to provide routable data packets. Since the MPLS PE router 109 may not be in the same geographical location as the B-RAS 105 or LNS 106, it may be necessary to forward and aggregate DSL traffic to these MPLS-enabled locations. Aside from its ability to aggregate multiple PPPoE sessions, L2TP is a routable protocol. This may permit an L2TP tunnel and its contents to be routed over an IP network. Traffic into the MPLS VPN PE router 109 may be segregated into different VPN's, while the second, MPLS LNS 108 may terminate DSL traffic and transmit the traffic as IP packets into the Internet 111.

The first LAC 104 may function as a provider of PPPoE over the LAC 104. The LNS 106 and B-RAS 105 may provide additional functions. The B-RAS 105 may serve as both a B-RAS 105 for DSL Internet traffic as well as a LAC 104 for MPLS destined PPPoE sessions. The LNS 106, aside from providing an aggregation and authentication point for Internet-bound DSL traffic may also function as an L2TP Tunnel Switch, switching PPPoE session destined to MPLS-enabled locations into a new set of tunnels, where the tunnel may comprise a packet based on one protocol wrapped, or encapsulated, in a second packet based on whatever differing protocol is needed in order for it to travel over an intermediary network. In effect, the second wrapper “insulates” the original packet and creates the illusion of a tunnel through which the wrapped packet travels across the intermediary network.

DSL traffic that may normally be intended for transmission into the Internet 111 may be routed through the LNS 106 and into customer VPN's. The LNS 106 may serve as a customer edge (CE) device. The CE device may be responsible for aggregating customer traffic received over the IP network 107. Examples of customer traffic may include distributed location entities such as automotive companies, financial and/or investment firms, insurance companies, and other companies that may have offices separated geographically.

Since DSL may be a regional service, it may be difficult to aggregate with the use of ATM's. With the network shown in FIG. 1, an IP network 107 may serve as a backbone to connect different regional ATM networks for customers. By integrating the use of L2TP with MPLS, the network 100 may take DSL as an aggregation or access method for customer traffic, without having to segregate IP traffic and DSL traffic. With the LNS 106, DSL may be routed into an MPLS network or into the PE router 109, in communication with the MPLS network. The PE router 109 may be located in the customer side of the Internet network 110, but the PE router 109 may also be located in the network 100 as a shared device to be used by multiple customers.

Like the tunnels from the B-RAS 105, the tunnels from the Tunnel Switch may be routed, either over a local network or over a regional or national IP network, to a new LNS 108 that may provide an aggregation point for MPLS destined traffic. This MPLS LNS 108 will provide a point of termination for the PPPoE sessions, permitting MPLS VPN customers to authenticate DSL sessions and provide IP addresses from their own address blocks.

While it may be possible to deploy a separate MPLS LNS 108 for each customer wanting DSL aggregation to an MPLS VPN, it may be desirable to use virtual routing capabilities to partition the MPLS LNS 108 for the use of multiple customers. The interconnection to the MPLS network may be either a shared medium, like ATM PVC's or Ethernet VLAN's, or separate physical connections, one per customer.

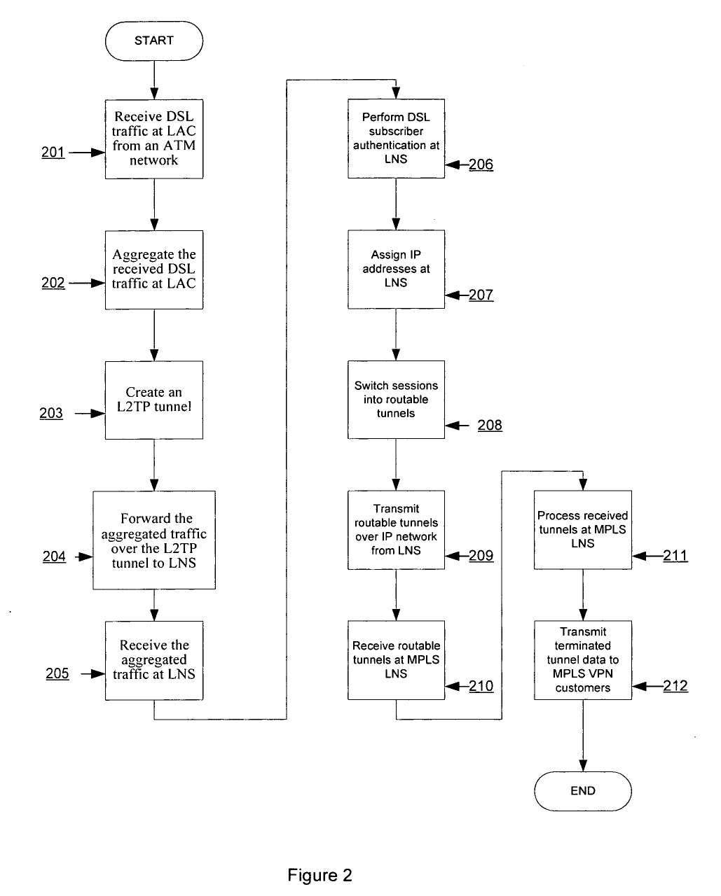

FIG. 2 illustrates an example process for connecting a DSL source to a network. An access concentrator may receive DSL traffic, at act 201, from a network, such as an ATM network. The access concentrator aggregates the received DSL traffic, at act 202, and create an L2TP tunnel, at act 203. The access concentrator forwards the aggregated traffic over the L2TP tunnel to an L2TP Network Server (LNS), using a PPPoE protocol via a network such as an ATM network, at act 204. The LNS receives the aggregated traffic through the network at act 205. The LNS may provide authentication functions, such as DSL subscriber authentication, at act 206. The LNS may also provide IP address assignment, at act 207. The LNS then switches data such as PPPoE sessions, designated for MPLS-enabled locations, into routable tunnels, at act 208. The routable tunnels may be transmitted, at act 209, over a network, such as an IP network. An MPLS LNS may receive the routable tunnels at act 210. The MPLS LNS then processes the received L2TP tunnels, such as by terminating the received L2TP tunnels, which may contain PPPoE sessions, at act 211. At act 211, the MPLS LNS terminates the PPPoE sessions within the received L2TP tunnels and assigns addresses to the PPPoE sessions. The MPLS LNS may transmit data, such as the terminated PPPoE tunnels over a network such as the Internet, to VPN customers, at act 212. The interconnection to VPN customers may be performed with a shared medium, such as ATM PVC's or Ethernet virtual local area networks (VLAN's), or separate physical connections, one per customer.

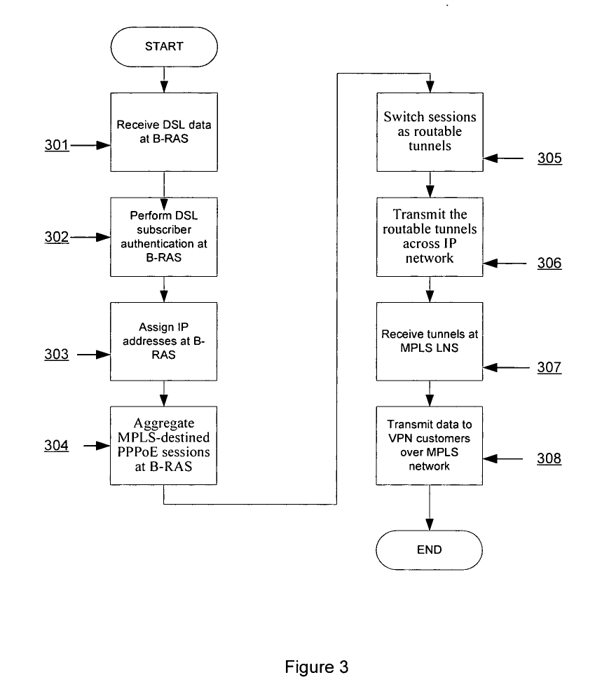

FIG. 3 illustrates a second example process for connecting a DSL source to a network through a broadband remote access server. A remote access server, such as a B-RAS may receive data, such as ATM PVC data, at act 301. The B-RAS may provide authentication functions, such as DSL subscriber authentication, at act 302. The B-RAS may also provide IP address assignment, at act 303. The B-RAS aggregates MPLS destined PPPoE sessions, at act 304. The B-RAS switches these sessions as a set of routable tunnels, at act 305. The B-RAS transmits the routable tunnels across a network, such as an IP network, at act 306. An MPLS LNS may receive the tunnels, at act 307. The MPLS LNS transmits data, such as the terminated PPPoE tunnels over a network such as the Internet, to VPN customers, at act 308. The interconnection to VPN customers may be performed with a shared medium, like ATM PVC's or Ethernet VLAN's, or separate physical connections, one per customer.

With the network 100 configured as in FIG. 1, customers may handle their own authentication and IP address assignments. Customers may have overlapping IP addresses with this system, since their traffic is segregated. DSL subscriber traffic never touches the Internet, and there is no gateway that has to bridge the more secure MPLS VPN with the Internet. The network 100 therefore provides a more cost-effective solution requiring fewer components while expanding customer options for DSL data connections.

Like the methods shown in FIGS. 2-3, the sequence diagrams may be encoded in a signal bearing medium, a computer readable medium such as a memory, programmed within a device such as one or more integrated circuits, or processed by a controller or a computer. If the methods are performed by software, the software may reside in a memory resident to or interfaced to the B-RAS 105, the LNS 106, a communication interface, or any other type of non-volatile or volatile memory interfaced or resident to the B-RAS 105 or the LNS 106. The memory may include an ordered listing of executable instructions for implementing logical functions. A logical function may be implemented through digital circuitry, through source code, through analog circuitry, or through an analog source such as through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any unit that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A digital subscriber link (DSL) network for routing data to a multi-protocol label switching (MPLS) virtual private network (VPN) comprising:
a source of DSL data connected to an asynchronous transfer method (ATM) network;
an access concentrator in communication with the ATM network;
a remote access server in communication with the ATM network, where the remote access server is configured as an access concentrator;
a first network server in communication with the ATM network, where the network server is configured as a layer 2 transport protocol (L2TP) tunnel switch to switch PPPoE sessions designated for MPLS-enabled locations into a new set of tunnels;
an internet protocol (IP) network, configured to route packets of data formatted with the internet protocol; and
a second network server in communication with the IP network, where the second network server is configured to aggregate and terminate the switched PPPoE sessions designated for MPLS-enabled locations.

2. The network of claim 1 where the access concentrator comprises a layer 2 transport protocol access concentrator.

3. The network of claim 1 where the remote access server comprises a broadband remote access server (B-RAS).

4. The network of claim 1 where the first network server comprises an L2TP network server (LNS).

5. The network of claim 4 where the second network server comprises an MPLS L2TP network server (LNS), and where the second network server is configured as a customer edge (CE) device to aggregate customer data.

6. The network of claim 5 where the customer data comprises DSL data.

7. The network of claim 5 where the second network server transmits the customer data to an MPLS provider edge (PE) device.

8. The network of claim 7 further comprising an MPLS network in communication with the second network server or the MPLS PE device.

9. The network of claim 8 where the communication with MPLS network comprises an ATM personal virtual circuit (PVC), an Ethernet (virtual local area network (VLAN), or a separate physical connection.

10. A method for connecting a DSL source to an MPLS VPN comprising:
receiving, at an access concentrator, DSL data from a first network, where the access concentrator is in communication with the network;
aggregating the DSL data at the access concentrator;
creating, by the access concentrator, an L2TP tunnel for the DSL data through the network;
forwarding the DSL data using a PPPoE protocol through the network to a network server in communication with the network;
receiving the DSL data at the network server;
processing the DSL data at the network server;
switching the DSL data to be routed to MPLS-enabled locations through a second network using routable tunnels;
transmitting the routable tunnels from the network server to an MPLS-enabled network server through the second network;
receiving the routable tunnels at the MPLS-enabled network server;
processing the routable tunnels at the MPLS-enabled network server; and
transmitting data associated with the processed tunnels to an MPLS network.

11. The method of claim 10 further comprising
receiving, at a remote access server, a source of DSL data from a network in communication with the remote access server;
processing the DSL data at the remote access server, where the remote access server is configured as an access concentrator;
aggregating, at the remote access server, DSL data to be routed to MPLS-enabled locations;
switching the DSL data to be routed to MPLS-enabled locations as a set of routable tunnels;
transmitting the routable tunnels to the MPLS-enabled network server over the IP network; and
receiving the routable tunnels at the MPLS-enabled network server.

12. The method of claim 10 where the DSL data to be routed to MPLS-enabled locations comprises PPPoE sessions.

13. The method of claim 10 where processing the DSL data at the network server comprises: authenticating the DSL data at the network server; and assigning IP addresses associated with the DSL data at the network server.

14. The method of claim 11 where processing the DSL data at the remote access server comprises: authenticating the DSL data at the network server; and assigning IP addresses associated with the DSL data at the network server.

15. The method of claim 11 where the remote access server comprises a broadband remote access server (B-RAS).

16. The method of claim 10 where transmitting data associated with the processed tunnels to an MPLS network comprises transmitting the data through an ATM PVC, an Ethernet VLAN, or a separate physical connection.

17. The method of claim 10 where the routable tunnels comprise L2TP tunnels, and where the L2TP tunnels further comprise PPPoE sessions.

18. The method of claim 17 where processing the routable tunnels at the MPLS-enabled network server comprises:
terminating the received L2TP tunnels;
terminating the PPPoE sessions within the received L2TP tunnels; and
assigning addresses to the PPPoE sessions.

19. The method of claim 10 where the first network comprises an ATM network and the second network comprises an IP network.

20. The method of claim 11 where the DSL data to be routed to MPLS-enabled locations comprises PPPoE sessions.
